(19) United States
(12) Patent Application Publication
(10) Pub. No.: US 2025/0271086 A1
(43) Pub. Date: Aug. 28, 2025

(54) Two Piece Large Pipe Quick Connect

(71) Applicant: TDW Delaware, Inc., Wilmington, DE (US)

(72) Inventors: Roger L. Poe, Beggs, OK (US); Jeff Berry, Owasso, OK (US); Jeff Redenius, Tulsa, OK (US)

(21) Appl. No.: 19/065,355

(22) Filed: Feb. 27, 2025

Related U.S. Application Data
(60) Provisional application No. 63/558,212, filed on Feb. 27, 2024.

(51) Int. Cl. F16L 23/00; F16K 27/04; F16L 23/036

(52) U.S. Cl. CPC F16L 23/003; F16K 27/044; F16L 23/006; F16L 23/036

(57) ABSTRACT

A connector of this disclosure is adapted connection to a slide gate valve of a hot tapping, plugging, and completion operation. In embodiments, a lower half of the connector includes, at an upper end, a horizontal first face surface having at least one secondary seal groove, a first guide surface extending in a vertical direction and having a primary seal groove, and a first periphery including a first part of a locking arrangement. The second half of the connector includes a housing and, at a lower end, a horizontal second face surface, a second guide surface shaped complementary to the first guide surface, and a second periphery including a second part of the locking arrangement. When the first and second parts of the locking arrangement are engaged with one another, relative rotation is prevented. The lower half of the connector may form a weldment with the slide gate valve.

### CROSS-REFERENCE TO CO-PENDING APPLICATIONS

This application claims priority to, and the benefit of, U.S. 63/558,212 filed Feb. 27, 2024.

### BACKGROUND

This disclosure is in the field of pipeline field service applications including hot tapping and plugging operations and service operations under vacuum and positive pressure and, in particular, joining of pipe and pipe related equipment used in those filed service applications.

In hot tapping, a saddle branch fitting is welded about a pipe and a valve is connected to the saddle branch fitting by way of bolts or threaded studs. Once the valve is secured to the saddle branch fitting, a housing adapted to receive a pipe service machine is then connected to the valve by way of another set of bolts or threaded studs.

As the pipe sizes increases in diameter the number of bolts or threaded studs to join the flanges of the saddle branch fitting and valve and of the valve and the housing increases as well. Further, as the pressure increases from 150-pound class pipe to 600- and 900-pound class pipe the amount of torque required to properly join the flanges to ensure a leak free connection increases and achieving this connection can take hours. At each stop of the process, a torque crew must remove connective equipment to the valve, add new equipment, and torque the new equipment down. This process repeats several times over while the pipe is cut, plugged for the service work to be initiated, finished and the valve and equipment removed. The cost of down time for a crew of people and equipment as they wait while a torque team tightens the restraining studs to the appropriate torque can run into thousands of dollars and typically tens of thousands of dollars.

Further, it is expensive to move personnel and equipment to and from the field site. For example, when tapping a line, cutting the line, or blowing down the line, the line needs to be free of only necessary people in case a fire should result during the process of the work. It can take hours to cut or restructure equipment, in which case the working personnel have to wait off to the side of the trench or, if elevated, off to the side at a distance in case a problem would occur. During the hours it may take to cut the pipe the personnel and equipment sit idle, away from the pipe.

Additionally, there has been a shift in the pipeline industry, particularly in Europe, where hydrogen is being mixed or blended with methane to lower greenhouse gas emissions. Where pipelines may have previously transported mostly natural gas, carbon dioxide, ammonia, petroleum liquids, and water, some are now transporting hydrogen blended with natural gas. A typical blend is about 5% to 10% hydrogen, but efforts are underway to increase this to 30% and even to as much as 50%.

Hydrogen, with a molecular weight of 2.016, is one of the smallest molecules and, therefore, one of the hardest to contain. Because the hydrogen molecule is so small, it can easily permeate through certain metals as well as into and past a seal's lattice structure or polymers. This permeation causes the seal to expand. The hydrogen can cause the seal to crack or bubble, creating leak paths through the seal. A small leak at high volume can pose safety and environmental concerns as well as result in millions of dollars of lost hydrogen and pipeline product over time.

Therefore, a need exists for a quick connect that can provide a leak-free connection and reduce the amount of time spent in the field securing the flanges.

### SUMMARY

Embodiments of a quick connect of this disclosure provide a leak-free connection; withstand the stress and strain of the hydraulic equipment typically used in hot tapping, plugging, and completion operations; and accommodate any of the tooling associated with those operations as the tooling passes into and out of the valve as well as their use on or in the pipe. The quick connect provides connections and disconnections that can be accomplished safely and quickly at each point of the overall service process without having to torque and retorque the bolts or threaded studs, thereby eliminating crew and equipment downtime associated with the prior art. In some embodiments, connections may be made in 30 minutes or less.

A quick connect of this disclosure may be used to join pipeline pieces in a range of 4″ to 48″ (100 mm to 1200 mm) or larger to facilitate pipeline field work; pipeline tapping work; pipeline work with fittings; pipeline work with gas, oil, water, sludges, and two-phase flows of any kind. The quick connect can be a replacement for pipeline flanges which have been used for decades as the industry standard.

In embodiments, the quick connect provides:
torque suppression plates which prevent the unit from rotating if the cutter stalls;
labyrinth seals to eliminate leakage rate for small molecular weight gasses (e.g., testing with helium, as a surrogate for hydrogen, has demonstrated leak rates of less than 1 SCF per day (˜0.028 Sm³) under high pressure conditions (e.g. 1600 psi or ˜ 110 bar)).

In some embodiments, the quick connect also provides one or more of the following:
parallel, non-wedging clam shell surfaces, which prevent reaction forces from opening the clam shell while under load;
access for a bleed port for equalization of the piping equipment; and
a pressure alert feature which prevents the operator from opening the unit while under pressure.

A pipe service system in which a quick connect of this disclosure may be used typically includes four sub-systems: (1) a saddle branch fitting of a kind known in the art and including collars for connection to a pipe and a flange for connection to a valve; (2) the valve itself, which is typically a slide gate valve of a kind known in the art; (3) a lower half of a quick connect of this disclosure including a flange for connection to the valve; and (4) a housing of this disclosure that includes an upper half of the quick connect.

In embodiments, a lower half of a quick connect of this disclosure can be secured to the valve prior to the valve arriving on site for connection to the saddle branch fitting. The connection may be done at the manufacturer providing the valve. In embodiments, the lower half of the quick connect is welded to the upper flange of the valve. This upper flange, like that of the lower flange, is typically connected to the valve by way of bolts or threaded studs located about the periphery of the valve. The housing which includes the upper half of the quick connect is then lowered onto the valve in the field, thereby causing the two halves of the quick connect to mate. The housing is adapted to receive and protect a tool of a pipe service machine such as, but not limited to, a cutting head of a STOPPLE® pipe service machine. A clam shell or band clamp than secures the two halves of the quick connect.

Both halves of the quick connect include guiding surfaces that come into contact with one another to help ensure proper alignment. In some embodiments, the guiding surfaces include a weld neck of the lower half. The guiding surface of the lower half of the quick connect may be a tapered or frusto-conical shaped neck; the guiding surface of the upper half of the quick connect being complementarily shaped. As the upper half is lowered, the geometry of the lower half of the quick connect helps to guide the upper half onto static lock plates of the lower half. Once the two halves of the quick connect are mated together, the clam shell or band clamp can be secured about the two halves.

In embodiments, the band clamp includes a primary seal and at least one secondary seal. The primary and secondary seals lie in different vertical planes and, together, present a tortious or non-linear path and subsequent pressure drop to any escaping fluid. In embodiments, the primary seal is the larger seal. In some embodiments, the primary seal is oriented to seal between the guiding surfaces of the two halves and the at least one secondary seal is oriented to seal between opposing horizontal mating surfaces of the two halves. When the clam shell or band clamp is closed the two halves of the quick connect create a singular device capable of holding high pipeline pressure with virtually zero leakage of low molecular weight gas such as hydrogen. The band clamp includes parallel, non-wedging clam shell surfaces which prevent reaction forces from opening the clam shell while under load.

Embodiments include a locking arrangement between the two halves of the quick connect that maintains the structural integrity of the overall geometry of the quick connect and withstands the maximum torque and radial momentum stored in the rotation of the cutting head, thereby preventing damage to the quick connect as a function of torque as the cutting head is cutting the opening into the pipeline. The locking arrangement may be in the form of static lock plates such as a longitudinally extending tab, dog or ear that, when engaged with a slot of the upper half of the quick connect, function as torque limiters or suppressors, thereby preventing rotation of the upper half of the quick connect housing relative to the valve should a cutting tool completely stall as the hydraulic unit is turning the cutting head. The static lock plates are positioned around the periphery of the lower component such that the two geometries are completely locked into place during the tapping/cutting procedure. In some embodiments, the lock plates are spaced apart 90° from one another along a periphery of the lower half of the quick connect, the slots of the upper half having a same spacing.

### BRIEF DESCRIPTION OF THE DRAWINGS

FIG. 1. is a view of an assembled system of this disclosure, including a lower (first) half of a quick connect that is secured to the valve and receives an upper (second) half of the quick connect located at a bottom end of a housing. The lower half of the quick connect may be secured to the valve prior to delivery at the field site. In embodiments, the lower half of the quick connect and the upper flange of the valve form a weldment.

FIG. 2 is an enlarged view of the two halves of the quick connect when mated. The lower half includes a series of static lock plates that engage slots of the upper half.

FIG. 3 is a view of the lower half of the quick connect prior to receiving the upper half. The lower half includes a primary seal groove along a vertical guide as well as at least one secondary seal groove along a horizontally oriented mating face. The primary and secondary seals provide a labyrinth or tortious path that any escaping fluid must traverse, with subsequent pressure drops along the way.

FIG. 4 is a view of the upper half of the quick connect. The upper half includes a complementary shaped guide to that of the lower half which seals against the primary seal as well as a mating face to the at least one secondary seal.

FIG. 5 is cross-section view of the quick connect when in a clamped state.

FIG. 6 is another embodiment of a quick connect of a pipe service machine—the same as, or similar to, that disclosed in WO 2020/181277 A1 to Zann et al., incorporated by reference herein—and adapted according to this disclosure to include a primary seal and at least one secondary seal.

FIG. 7 is an isometric view of an embodiment of an access fitting for the pipe service machine of FIG. 6 and adapted for use with a sealing system of this disclosure.

### ELEMENTS AND NUMBERING USED IN THE DRAWINGS AND DESCRIPTION

10 quick connect.
20 lower or first half quick connect 10
23 first locking part
23P lock plates
25 portion captured by clamp 60
27 upper end
29 primary seal groove
29S primary seal
31 secondary seal groove
31S secondary seal
33 locking arrangement
35 face surface (first face surface)
37 guide surface (first or lower guide surface)
39 periphery (first periphery)
40 upper or second half of quick connect 10
41 housing
43 second locking part
43S slots
45 portion captured by clamp 60
47 lower end
49 face surface (second face surface
51 guide surface (second or upper guide surface)
53 periphery (second periphery)
55 face surface to primary seal
60 clamp or clam shell
61 parallel, non-wedging surfaces
63 pressure alert
70 bleed port
45 lower end
47 face surface
49 guide surface
51 periphery
S saddle branch fitting
C lower and upper collar
L flange (to lower end of valve)
U flange (to upper end of valve)
V valve
V_{U} upper end of valve
V_{L} lower end of valve
W weldment

### DESCRIPTION

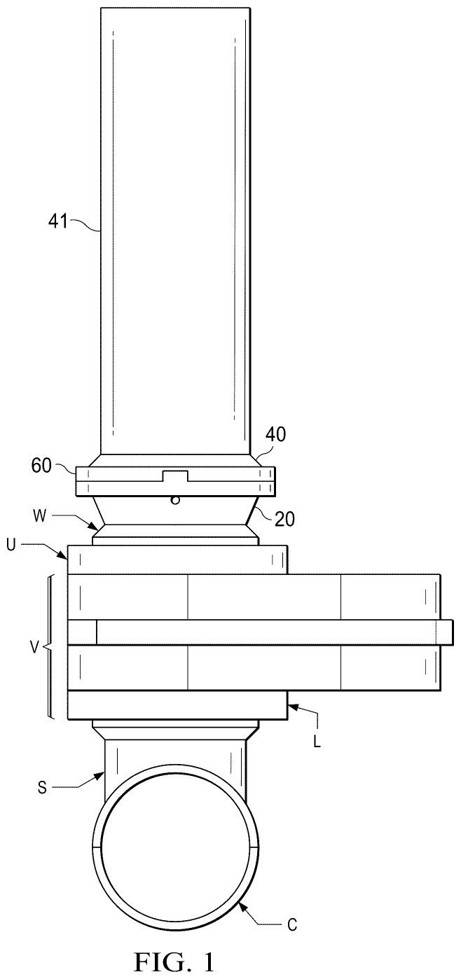

Referring first to FIG. 1 a pipe service system in which a quick connect 10 of this disclosure may be used includes four sub-systems: (1) a saddle branch fitting S of a kind known in the art and including a set of collars C for connection to a pipe (not shown) and a flange L for connection to a lower end V_{L} of a valve V; (2) the valve V itself, which is typically a slide gate valve of a kind known in the art; (3) a lower half 20 of a quick connect 10 of this disclosure adapted for connection to the slide gate valve V and including a flange U for connection to an upper end V_{U} the valve V; and (4) a housing 41 of this disclosure that includes an upper half 40 of the quick connect 10. Threaded bolts and nuts (not shown) are used to secure the valve V to the saddle branch fitting S.

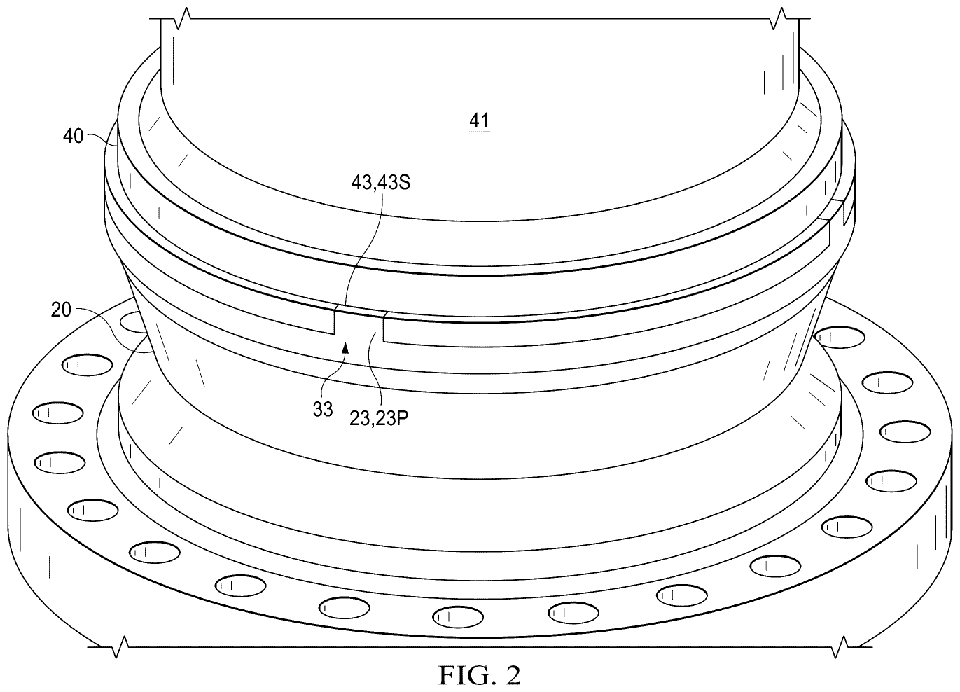

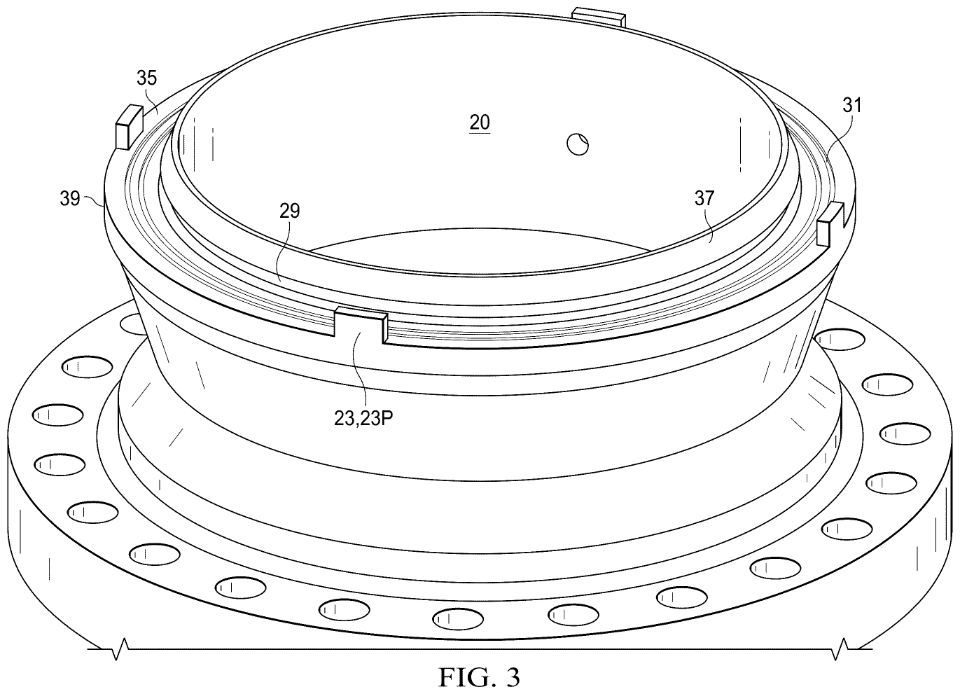

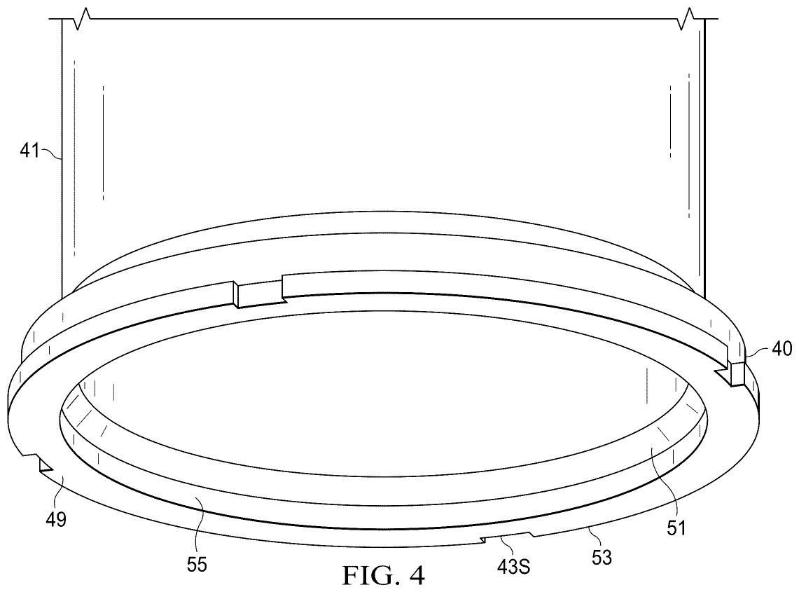

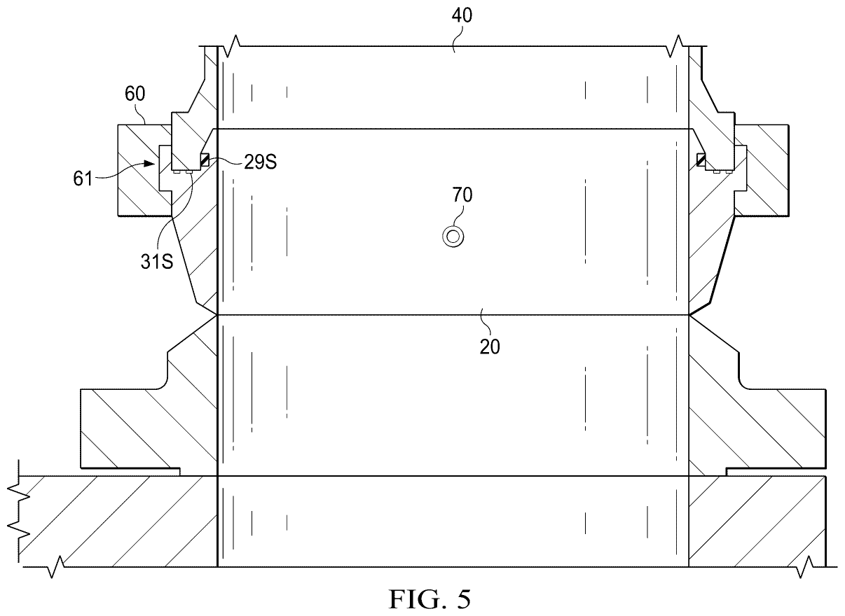

Referring now to FIGS. 2-5, a quick connect (“connector”) 10 of this disclosure is adapted for use with a slide gate valve V. In embodiments, the connector 10 includes a lower (“first”) half 20 and a second (“upper”) half 40 that each have complementary parts 23, 43 of a locking arrangement 33. When the parts 23, 43 of the locking arrangement 33 are engaged with one another, rotation of the parts 23, 43, and therefore each half 20, 40, relative to one another is prevented.

The connector 10 further includes a clamp 60 sized to surround the first and second halves 20, 40 and capture at least a portion 25, 45 of the first and second halves 20, 40. In embodiments, the clamp 60 includes parallel, non-wedging surfaces 61 opposite the portion 25, 45 of the first and second halves 20, 40 captured by the clamp 60. The clamp 60 may further include a pressure alert 63. The connector 10 may also include a bleed port 70 located on the first half 20 or the second half 40.

In some embodiments, the first half 20 of the connector 10 can form a weldment W with the valve V by way of the flange U and is sent to the job site. In other embodiments, the first half 20 is separate from the valve V and connected to the valve V at the job site.

The first half 20 has, at its upper end 27, a primary seal groove 29 and at least one secondary seal groove 31. The secondary seal groove 31 is located on a generally horizontal face surface 35 of the half 20 (“first face surface”). The primary seal groove 29 is located on a guide surface 37 that extends in a generally vertical direction (“first guide surface”). In some embodiments, the first guide surface 37 is an inclined guide surface at least in part. The periphery 39 (“first periphery”) includes the first part 23 of the locking arrangement 33.

The second half 40 of the connector 10 include a housing 41 and, at a lower end 47, a generally horizontal face surface 49 (“second face surface”), a guide surface 51 (“second guide surface”) shaped complementary to the first guide surface 37, and a periphery 53 (“second periphery”) including the second part 43 of the locking arrangement 33. The periphery 53 may comprise a flange. The second and first face surfaces 49, 35 are mating surfaces. The second half 40 may further include another face surface 55 for mating a primary seal 29S.

The first part 23 of the locking arrangement 33 may be a plurality of spaced apart, longitudinally extending plates 23P and the second part 43 of the locking arrangement 33 may be a plurality of spaced apart slots 43S. In other embodiments, the second part 43 of the locking arrangement 33 is the plurality of spaced apart, longitudinally extending plates and the first part 23 of the locking arrangement is the plurality of spaced apart slots. The plates 23P, when engaged with the slots 43S, function as torque limiters. In some embodiments, the plate 23P is longitudinally extending tab, dog or ear.

A primary seal 29S resides in the primary seal groove 29 and a secondary seal 31S is located in the secondary seal groove 31. The primary seal 29S is larger in diameter than the secondary seal 31S. The second half 40 may further include another face or mating surface 53 opposite primary seal 29S. The primary seal groove 29 and at least one secondary seal groove 31 reside in different vertical planes.

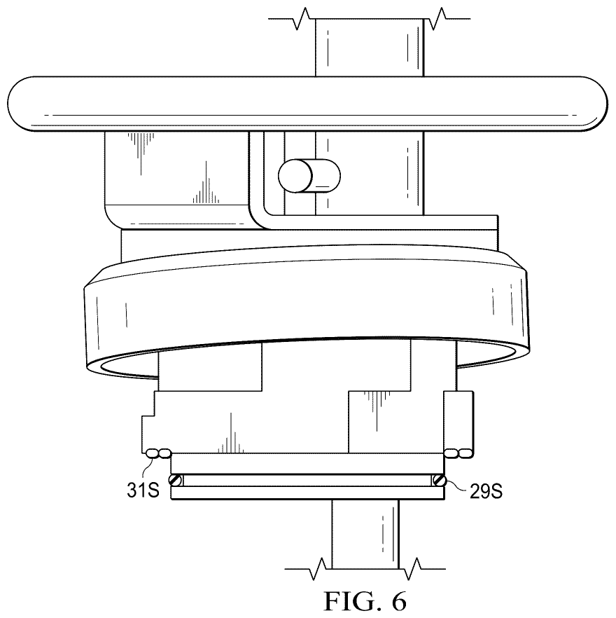

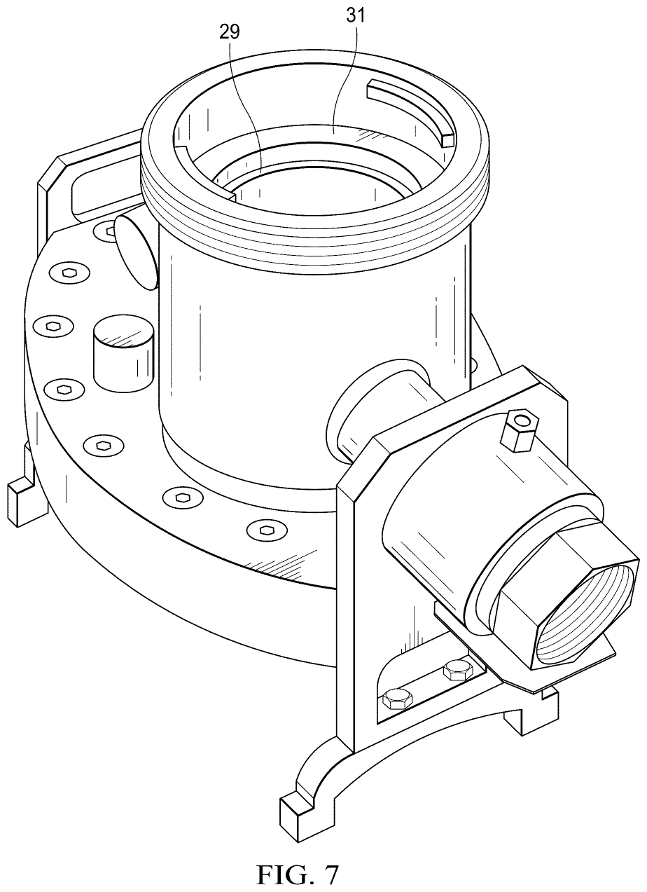

Referring now to FIGS. 6 and 7 a quick connect 10 like that disclosed in WO 2020/181277 A1 to Zann et al., incorporated by reference herein can be adapted according to this disclosure to include a primary seal groove 29 and primary seal 29S and at least one secondary seal groove 31 and secondary seal 31S.

While embodiments of a quick connect of this disclosure have been described, the scope of the invention is defined by the following claims, the recited elements and limitations of which are entitled to their full range of equivalents.

1. A connector adapted for connection to a slide gate valve, the connector comprising:
a first half including, at an upper end, a generally horizontal first face surface having at least one secondary seal groove, a first guide surface extending in a generally vertical direction and having a primary seal groove, and a first periphery including a first part of a locking arrangement;
a second half including a housing and, at a lower end, a generally horizontal second face surface, a second guide surface shaped complementary to the first guide surface, and a second periphery including a second part of the locking arrangement; and
wherein when the first and second parts of the locking arrangement are engaged with one another, rotation of the second part of the connector relative to the first part is prevented.

2. The connector of claim 1, wherein the first part of the locking arrangement is a plurality of spaced apart, longitudinally extending plates and the second part of the locking arrangement is a plurality of spaced apart slots.

3. The connector of claim 1, wherein the second part of the locking arrangement is a plurality of spaced apart, longitudinally extending plates and the first part of the locking arrangement is a plurality of spaced apart slots.

4. The connector of claim 1 further comprising a primary seal and a secondary seal located in a corresponding one of the primary seal groove and at least one secondary seal groove.

5. The connector of claim 1 wherein the primary seal groove and at least one secondary seal groove reside in different vertical planes.

6. The connector of claim 1 further comprising a bleed port located on the first half or the second half of the connector.

7. The connector of claim 1 further comprising a clamp sized to surround the first and second halves of the connector and capture at least a portion of the first and second halves.

8. The connector of claim 7 wherein the clamp includes parallel, non-wedging surfaces opposite the at least portion of the first and second halves captured by the clamp.

9. The connector of claim 7 wherein the clamp includes a pressure alert.

10. The connector of claim 1 wherein the first half of the connector further comprises a flange adapted for connection to the slide gate valve.

11. The connector of claim 10 wherein the first half of the connector forms a weldment with the slide gate valve.

12. The connector of claim 1 wherein the first guide surface of the first half is an inclined guide surface at least in part.

13. The connector of claim 12, the inclined guide surface is a neck portion of the first half of the connector.

14. A pipe service system comprising:
a slide gate valve;
a saddle branch fitting including a set of collars for connection to a pipe and a flange adapted for connection to a lower end of the slide gate valve;
a connector adapted for connection to an upper end of the slide gate valve and comprising:
a first half including, at an upper end, a generally horizontal first face surface having at least one secondary seal groove, a first guide surface extending in a generally vertical direction and having a primary seal groove, and a first periphery including a first part of a locking arrangement;
a second half including a housing and, at a lower end, a generally horizontal second face surface, a second guide surface shaped complementary to the first guide surface, and a second periphery including a second part of the locking arrangement;
a primary seal residing in the primary groove and a secondary seal residing in the at least one second seal groove, the primary seal being larger in diameter than the secondary seal;
a clamp sized to surround the first and second halves of the connector and capture at least a portion of the first and second halves;
wherein when the first and second parts of the locking arrangement are engaged with one another, rotation of the second part of the connector relative to the first part is prevented.

15. The pipe service system of claim 14 wherein a first half of the connector includes a flange adapted for connection to an upper end of the slide gate valve.

16. The pipe service system of claim 14 wherein the first half of the connector forms a weldment with the slide gate valve.
